(19) United States
(12) Patent Application Publication
(10) Pub. No.: US 2021/0171359 A1
(43) Pub. Date: Jun. 10, 2021

(54) TWO-STAGE FILTER FOR REMOVING MICROORGANISMS FROM WATER

(71) Applicant: Aqua Guidance Technologies, Ltd., Nassau (BS)

(72) Inventors: Symon Thomas, Brundall (GB); Andrew Lombardo, Pompano Beach, FL (US)

(21) Appl. No.: 17/116,621

(22) Filed: Dec. 9, 2020

Related U.S. Application Data
(60) Provisional application No. 62/946,150, filed on Dec. 10, 2019.

(51) Int. Cl. C02F 1/00; B01D 29/52; B01D 29/56; C02F 1/44

(52) U.S. Cl. CPC C02F 1/001; B01D 29/52; C02F 2101/30; C02F 1/44; C02F 2303/04; B01D 29/56

(57) ABSTRACT

A filter system is provided that comprises a first filter element in fluid communication with a source of a fluid, wherein the fluid flows through the first filter element and a second filter element in fluid communication with the first filter element, wherein the fluid, flowing through the first filter element flows through the second filter element and is discharged. The first filter element comprises a material adapted to stop the passage of materials greater than a selected size. The second filter element is adapted to remove an organic substance from the liquid.

This application claims priority under 35 U.S.C. § 119 to U.S. Provisional Patent Application No. 62/946,150, filed on Dec. 10, 2019. The disclosure of that application is incorporated herein by reference.

### BACKGROUND

### Field

The present invention relates to filters and media for filters for removing substances and particles from water. In particular, the present invention relates to a two-stage filter system wherein a prefilter element performs a first filter function for removing larger particles and organic matter from water and second stage removes viruses and dissolved substances such as organic acids from the prefiltered water.

### Description of the Related Art

Water filters provide a means for removing contaminants from water that might otherwise render water unpalatable or unhealthy. Ceramic filters rely on a porous element with passages sized to prevent the passage of particles above a certain size, for example, above 0.5 microns. Such filters can capture and retain particulate material, including bacteria.

Ceramic filters may be ineffective in removing contaminants that are smaller than the size of the passages in the porous element. Dissolved chemicals, for example, metals and very small particles, for example, viruses may be able to pass through the ceramic element.

Membrane filters are also used to remove contaminants from water. The membrane is formed from a porous material with a pore size that is small enough to prevent the passage of particles that are to be removed from the effluent. The membrane may be formed into an array of hollow fibers. The hollow fiber membranes are arranged to allow effluent to flow into the inside of the fiber and out though the surface of the fibers, or vice versa so that particles larger than the membrane pores are excluded from the filtered water.

A problem with these filters is that the amount of material they can sequester from water is limited. To keep the flow of water through a ceramic element at an acceptable level, the ceramic element may need to be cleaned or replaced periodically. Likewise, hollow fiber membranes can become clogged with contaminant particles and may need to be replaced periodically.

Another problem with known filter systems is that filter elements that remove very small particles and dissolved substances, such as organic acids and viruses may be unsuitable for removing larger particles because the larger particles rapidly clog the filter material. As larger particles and other materials accumulate on the surface of the filter element design for removing very small components, the pressure drop across the filter increases rapidly. In regions where there are high concentrations of particulate matter in the water supply, it may be impractical to use a filter to remove small particles (e.g., viruses) and to remove dissolve organic acids.

Known filters have a limited effectiveness to remove viruses from water where organic acids, such as humic acid, are present. It is believed that organic acids tend to clog filters with pore sizes small enough to physically sequester virus particles. This may make known filters ineffective in treating water in regions where water supplies are contaminated by organic acids and where harmful viruses are also present.

### SUMMARY

The present disclosure relates to apparatuses and methods to address these difficulties.

According to one embodiment, a filter system is provided that comprises a first filter element in fluid communication with a source of a fluid, wherein the fluid flows through the first filter element and a second filter element in fluid communication with the first filter element, wherein the fluid, flowing through the first filter element flows through the second filter element and is discharged. The first filter element comprises a material adapted to stop the passage of materials greater than a selected size. The second filter element is adapted to remove organic substances, such as organic acids, from the liquid. The fluid has a first initial concentration of an organic acid and a second initial concentration of a virus. After passing through the system the first initial concentration is reduced by greater than a first factor and the second initial concentration is reduced by greater than a second factor at a first flux of fluid.

According to another embodiment there is disclosed a filter system comprising a first filter element in fluid communication with a source of a raw fluid, wherein the raw fluid flows through the first filter element to generate a prefiltered fluid; and a second filter element in fluid communication with the first filter element, wherein the prefiltered fluid from the first filter element flows through the second filter element to generate a filtered fluid, wherein the first filter element comprises a material adapted to stop the passage of materials greater than 0.5 micron, wherein the second filter element is adapted to remove an organic substance from the fluid, wherein the organic substance comprises an organic acid, wherein the raw fluid has an initial concentration of the organic acid, wherein, the initial concentration of the organic acid in the raw fluid is reduced by between about 40% and about 60% to generate the prefiltered fluid with a prefiltered concentration of the organic acid, and wherein after the prefiltered fluid flows through the second filter element, the prefilter concentration of organic acid is reduced by greater than about 80% to a filtered concentration of the organic acid in the filtered fluid. The fluid may be water. The first filter element may comprise one or more of a ceramic body and a hollow fiber membrane filter. The filter system may comprise a reservoir holding a quantity of the fluid, wherein the reservoir, the first filter element, and the second filter element are arranged vertically and wherein the fluid flows from the reservoir and through the first and second filter elements by a pressure gradient caused by gravity. The second filter element may comprise first filter media particles adhered to surfaces of second media particles by a non-thermoplastic gluing material. The non-thermoplastic gluing material may comprise a polymer comprising chitosan and poly-diallyl dimethyl ammonium chloride; a vehicle comprising water; and a solubilizing agent, wherein the solubilizing agent comprises one or more of tartaric acid, acetic acid, formic acid, propionic acid, ascorbic acid, glutamic acid, lactic acid, maleic acid, malic acid, succinic acid, carboxylic acid, and combinations thereof. The second filter element may further comprise a binder and wherein the second media particles are adhered to one another by the binder. The filter system may comprise a first housing in fluid communication with the reservoir and holding the first filter element, a second housing holding the second filter element, and a coupling in fluid connection between the first housing and second housing, wherein the coupling extends through a vertical distance from the first housing to the second housing, and wherein a head pressure at the second filter element is greater than 0.25 psi. The filter system may further comprise an ambient pressure equalization tube, the tube extending vertically upward from the first housing, wherein the fluid in the reservoir defines a fluid level, and wherein the tube extends vertically above the fluid level. The first and second filter elements may be removably housed in the respective first and second housings. The organic substance may further comprise one or more of bacteria, viruses, and cysts. The organic acid may be one or more of humic acid, fulvic acid, and tannic acid. The second filter element may comprise a porous material with a total pore volume is greater than about 0.4 cc/g, where the percentage of the total pore volume provided by epipores is above about 40%, and wherein the pore volume provided by micropores is less than about 0.1 cc/g. A flux of fluid through the filter system may be greater than 0.7 ml/min/cm2. The first filter media particles may have a first mean particle size, the second media particles may have a second mean particle size, the first media particles may be adhered to surfaces of the second media particles with the non-thermoplastic adhesive to form filter material particles, the filter material particles may have a third mean particle size, and the third mean particle size may be larger than the first mean particle size. The first mean particle size may be between about 1 and about 75 um. The second mean particle size may be between about 75 and about 3000 um. The third mean particle size may be between about 75 um and 2000 um. The second filter element may further comprise a binder, wherein the filter material particles are connected with one another by the binder to form the filter element, wherein interstitial spaces are formed between filter material particles, and wherein a portion of the first filter media particles are positioned within the interstitial spaces. The first housing may comprise a plurality of first housings, each housing having a respective one of a plurality of first filter elements, wherein the hose comprises one or more branches, and wherein the coupling comprises a hose that connects the plurality of first housings to the second housing.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross section of a fluid reservoir and catch basin including a filter apparatus according to an embodiment of the disclosure;

FIG. 2 is a cross section of a fluid reservoir and catch basin including filter apparatus according to another embodiment of the disclosure;

FIG. 3 is a cross section of a fluid reservoir and catch basin including a filter apparatus according to another embodiment of the disclosure;

FIG. 4 is a cross section of a fluid reservoir and catch basin including a filter apparatus according to another embodiment of the disclosure;

FIG. 5 is a cross section of a fluid reservoir and catch basin including a filter apparatus according to another embodiment of the disclosure;

FIG. 6 is a cross section of a fluid reservoir and catch basin including a filter apparatus according to another embodiment of the disclosure; and

FIG. 7 is a cross section of a fluid reservoir and catch basin including a filter apparatus according to another embodiment of the disclosure.

### DETAILED DESCRIPTION

The present disclosure provides embodiments of a water filtration systems including filter elements and filter media that reduce the concentration of harmful substances and/or organisms in water, while providing a relatively high flow rate or flux and low pressure drop.

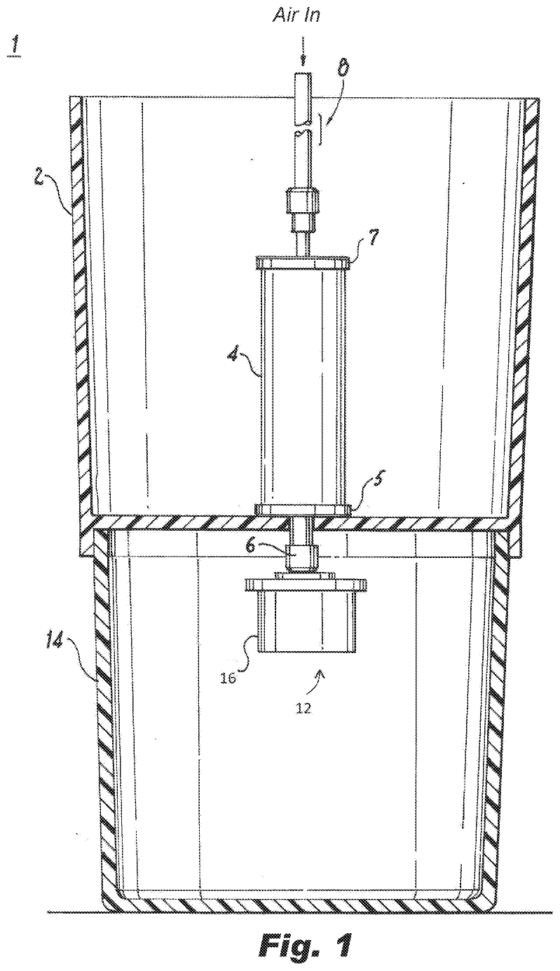

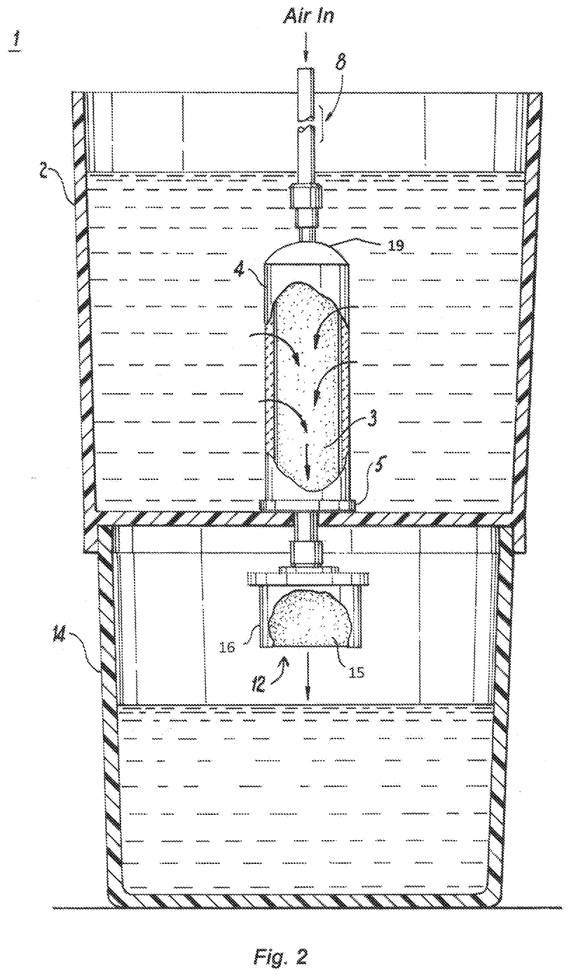

FIGS. 1 and 2 show a filtration system 1 according to embodiments of the present disclosure. A raw water reservoir 2 holds a quantity of water or other fluid to be filtered. The reservoir 2 may be open at the top, may have a removable lid, or may be a closed container with an inflow tube to allow unfiltered water to be delivered to the apparatus. First element 4 is positioned within reservoir 2. First filter element 4 may have a hollow interior space 3 surrounded by a porous wall as will be described below.

At the bottom of the first filter element 4 is a coupling portion 6. Coupling portion 6 may comprise screw threads, a snap fitting, an interference fitting, or other removable coupling feature known to those of ordinary skill in the field of the disclosure that allows the bottom end of the coupling to removably connect with the first filter element 4 and a second filter element 12, as will be described below. As shown in FIG. 2, second filter element 12 comprises an outer housing 16 holding filter material 15. Coupling portion 6 is sealed to the bottom surface of reservoir 2. According to one embodiment, an o-ring seal is provided between a flange on the outer surface of coupling portion 6 and the bottom of reservoir 2 to prevent water from leaking from around the coupling. A fluid passage is provided through coupling portion 6 to allow water filtered by the first filter element 4 to flow under the force of gravity downward through the coupling.

According to one embodiment, first filter element 4 is formed as a hollow cylinder. Water in reservoir 2 flows radially inward through the surface of the cylinder and downward out the bottom of the cylinder through coupling portion 6. As shown in FIG. 1, according to one embodiment first filter housing portions 5 and 7 are provided on either end of the cylindrical element 4. Housing portion 5 couples with coupling portion 6. According to one embodiment, portion 5 couples with portion 6 by a threaded engagement. According to other embodiments, portions 5 and 6 couple using other arrangements know to those of skill in the field of the disclosure, for example, by a quick-connect, a snap connection, by a dairy fitting, by an interference fit, and the like.

According to another embodiment, shown in FIG. 2, filter element 4 is open at one end and closed by a domed-shaped portion 19 on the other end. A housing portion, such as portion 5 discussed with respect to FIG. 1 is provided at the lower end of element 4 in this embodiment. In this embodiment, water flows radially inward through the cylindrical wall as well as downward through the dome-shaped portion into the interior hollow space 3 of the filter element and downward through coupling 6.

A second filter element 12 is provided below reservoir 2. Housing 16 of second element 12 is connected with the lower end of coupling 6 so that water entering the housing from coupling 6 flows through filter material 15. An opening is provided at the bottom of housing 16. According to one embodiment, filter material 15 of the second filter element 12 is immobilized into a solid body in the form of a puck, block, cylinder, or the like as described in co-pending U.S. patent application Ser. No. 16/176,398, filed Oct. 31, 2018, which is incorporated herein by reference. The body may comprise flat faces at the top and bottom of the element. Water flowing downward from coupling 6 flows axially through element 12 and interacts with the materials 15 forming the element so that contaminants, such as organic acids and viruses are removed from the water or are denatured to render them harmless. According to a further embodiment, second element 12 and filter material 15 are arranged so that water flowing from coupling 6 enters a central hollow region of filter material 15 and flows radially outward through the second filter element and then downward through the opening at the bottom of housing 16. One such filter According to other embodiments, instead of forming a solid body, second filter element material 15 is a loose material contained within housing 16.

A catch basin 14 is provided below housing 16. Water from reservoir 2 is filtered as it passes through first element 4 and second element 12. The filtered water pass through the opening at the bottom of housing 16 and is collected in catch basin 14.

According to one embodiment, first filter element 4 is provided with a pressure equalizing tube 8. Tube 8 connects with hollow space 3 inside filter element 4 and extends from the top-most portion of element 4 to a point above the level of water in the reservoir. Tube 8 allows air at ambient pressure to flow into and out of the hollow space 3 inside first filter element 4 to avoid trapping air bubbles that might impeded flow through the first filter element. By eliminating air that may become trapped inside filter element 4, flow though the filter element may be improved.

According to the embodiment shown in FIG. 1, housing portion 7 at the top end of element 4 couples with tube 8. Portion 7 and tube 8 may be permanently connected with one another or may be joined by a removable connection, for example, by a threaded connection, a quick connect, a snap-fit connection, a dairy fitting, an interference fit and the like. According to the embodiment shown in FIG. 2, tube 8 extends though the dome-shaped portion 19 of element 4. According to either embodiment, tube 8 is preferably in fluid communication with the space at the top-most portion of element 4 to allow substantially the whole volume of any air trapped inside element 4 to escape.

According to one embodiment, coupling 6 connects with housing 16 by a removable coupling, for example, a threaded connection. This allows the filter 12 and housing 16 to be removed from the filter system and replaced, for example, when element 12 has reached the end of its useful lifetime. According to other embodiments, instead of a threaded connection, other fluid tight connections know to those of skill in the field of the disclosure could be used, for example, a quick-connect snap connection, a dairy fitting, a friction fit interference connection, and the like.

According to one embodiment, the first filter element 4 is a porous ceramic body. Pores in the body are designed to capture particles in water above a certain size, for example, greater than about 0.5 microns. Preparation of such a ceramic filter element, sometimes called ceramic candle filter, is well known in the field of the disclosure. According to a further embodiment, the first filter element 4 includes materials that create chemically or physically active sites that interact with water to remove or render harmless certain contaminants and/or microorganisms. Material including metal ions, for example, silver ions may be incorporated into element 4. Such metal ions are known to kill or immobilize certain microorganisms. Filter element 4 may also incorporate materials with active sites, such as activated carbon, which is known to sequester certain substances from water, for example, metals such as lead and ions such as chlorine ions. According to another embodiment, first filter element 4 comprises other materials than ceramic. Filter element 4 may comprise paper, polymer fibers, polymer fibers or particles, glass fibers or particles, or unsintered ceramic particles or fibers. According to another embodiment, first filter element 4 comprises a membrane filter. The membrane may be formed as a sheet and arranged so that unfiltered water flows through the sheet. The membrane may also be formed as an array of hollow fibers and arranged so that unfiltered water flows through the walls of the fibers.

Physical filters such as ceramic candle filter elements are known to accumulate particles and other substances filtered from water. As particles accumulate on the surface and within the element, the rate at which water can be filtered through the element may diminish. First element 4 can be periodically removed from the apparatus, for example, by disconnecting housing portion 5 from coupling 6. The filter element can be cleaned or replaced by the user to maintain an adequate flow of filtered water. In the embodiment shown in FIG. 1, tube 8 may also be disconnected from housing portion 7 to facilitate cleaning and/or replacement of filter element 4.

Also as shown in FIG. 1, second filter element 12 and housing 16 are disconnected the apparatus by disconnecting coupling portion 6 and housing 16. As the filter system 1 is used, substances such as organic acids may be sequestered by material 15 in second filter element 12, as will be described below. The performance of the filter system 1 may diminish, for example, by having a reduced flow of water through the filter as the capacity of second element 12 to hold such substances is reached. A user can remove element 12 and replace it with a new assembly to maintain an adequate flow of water through the system.

According to a further embodiment, the second filter element material 15 is prepared by adhering smaller particle size filter particles to the surfaces of larger sized filter particles and binding the larger filter particles with one another to create a filter element with an open spaced structure. According to some embodiments, the smaller and larger filter particles have an activated surface and a pore structure that advantageously adsorbs substances from water. Filter media and filter elements formed with such a structure is disclosed in U.S. Provisional Patent Appl. No. 62/868,885, filed Jun. 29, 2019 and co-pending U.S. patent application Ser. No. 16/915,166, filed on Jun. 29, 2020, which are incorporated herein by reference.

According to another embodiment, second filter element material 15 is prepared using materials that effectively remove certain contaminants from water. Element 12 may be formed from porous materials that filter organic acids from water. Such elements are described in U.S. Provisional Patent Appl. No. 62/868,883, filed Jun. 29, 2019 and co-pending U.S. patent application Ser. No. 16/915,125, filed on Jun. 29, 2020, which are incorporated herein by reference. Element 12 according to this embodiment is formed using porous materials where a substantial portion of the pore volume is provided by pores in the range of epipores, that is, pores with a diameter greater than about 5 nm. These porous materials may include smaller sized filter particles adhered to the surfaces of larger sized filter particles to form an open spaced structure, as described above.

An advantage of filter systems according to the present disclosure is that by using a filter element were a significant portion of the pore volume is provided by epipores as the second element material 15, the concentrations of both organic acids and viruses can be reduced significantly.

According to one embodiment, a filter system according to the disclosure was formed with a first filter element 4 as a ceramic filter. Such an element removes particles larger than about 0.5 micron from the water. This includes most bacteria. According to one embodiment, the ceramic first filter element 4 reduces the concentration of bacteria by greater than 99.9999%, that is, reduces the concentration of bacteria by 6 log. Ceramic first filter element 4 may also reduce the concentration of organic acids, such as humic acid by physically excluding organic acid molecules from the effluent. According to one embodiment, the ceramic element reduces humic acid concentration by about 50%. According to another embodiment, where the ceramic element filters water with an initial concentration of humic acid at about 10 parts per million (ppm), the humic acid concentration is reduced to about 6 ppm.

Second filter element material 15 may be formed as follows. To effectively remove organic acids, material 15 may be formed from porous materials where a significant portion of the pore volume is provided by pores that are larger than about 5 nanometers (nm), i.e., epipores. Such material may include carbon compounds such as but not limited to lignite, anthracite, or bituminous coal, peat, oil, tar, carbonized organic matter such as wood, bamboo, coconut husk, or bone, from zeolite particles such as, but not limited to, analcime, leucite, pollucite, wairakite, clinoptilolite, barrerite, chabazite, phillipsite, amicite, or gobbinsite, from a calcium compound such as monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, diatomaceous earth, expanded glass or ceramic particles, pumice, and the like.

According to one embodiment of the disclosure, the particles 15 forming second filter element 12 have a specific total pore volume preferably between about 0.4 cc/g and about 3.0 cc/g, more preferably from about 0.8 cc/g to about 1.8 cc/g, and most preferably between about 1.2 cc/g and 1.6 cc/g. According to a preferred embodiment, greater than about 40% of the pore volume is contributed by epipores, more preferably greater than about 50% contributed by epipores, and still more preferably greater than about 60% contributed by epipores. According to a most preferred embodiment, greater than about 65% of the total pore volume is contributed by epipores.

According to some embodiments, the second filter element comprises: a filter media having a total pore volume and comprising porous filter particles; a non-porous filter material; and a binder, wherein the total pore volume is greater than about 0.4 cc/g and where the percentage of the total pore volume provided by epipores is above about 40%, and wherein, when subject to an influent flux greater than about 0.7 ml/min/cm² the filter element reduces an initial concentration of an organic acid in water by greater than 80%. The filter media may have a total pore volume of between 0.4 cc/g and 1.2 cc/g and the pore volume provided by micropores may be less than about 0.1 cc/g. The filter element may have a total pore volume of about 0.5 cc/g.

The particles may be provided as a combination of smaller lignite particles and larger lignite particles. According to one embodiment, the smaller particle size material comprises particles with a mean diameter (D50) of between 1 micron and 180 microns. According to a more preferred embodiment, the smaller particle size material comprises particles with a mean diameter (D50) of between 10 microns and 75 microns. According to a most preferred embodiment, the smaller particle size material comprises particles with a mean diameter (D50) of about 15 microns. According to another embodiment, the larger particle size material comprises particles with a mean diameter (D50) of between 75 microns and 3000 microns. According to a more preferred embodiment, the larger particle size material comprises particles with a mean diameter (D50) of between 100 microns and 2000 microns. According to a most preferred embodiment, the larger particle size material comprises particles with a mean diameter (D50) of about 1500 microns.

The smaller and larger particle size materials may be treated with a gluing solution so that the smaller particles are adhered to the surfaces of the larger particles. This arrangement provides voids in filter element 10. These voids provide an improved flow rate and reduced pressure drop across the filter element. Not wishing to be bound by theory, it is believed that because the smaller particles reside in the voids between the larger particles, water flowing through the filter element interacts with the porous particles to allow contaminants such as humic acid, and viruses and be adsorbed or rendered inactive.

As described in U.S. Provisional Patent Appl. No. 62/868,885, filed Jun. 29, 2019, and co-pending U.S. patent application Ser. No. 16/915,166, filed Jun. 29, 2020 which are incorporated herein by reference, the second filter element is formed from media particles adhered with one another by a gluing solution. According to some embodiments there is disclosed a method for forming a filter element comprising the steps of: providing first filter media particles having a first mean particle size; providing second filter media particles having a second mean particle size, wherein the second mean particle size is larger than the first mean particle size; forming a gluing solution, wherein the gluing solution comprises a vehicle, a non-thermoplastic adhesive, and a solubilizing agent; mixing second filter media particles with the first filter media particles and the gluing solution to form a filter media mixture; blending the gluing solution and filter media mixture to form a media blend; drying the blend, wherein a substantial portion of the vehicle is evaporated from the media blend; and decomposing the agent, wherein the non-thermoplastic adhesive binds the first filter media particles to surfaces of the second filter media particles. The solubilizing agent may enhance dissolution of the non-thermoplastic adhesive in the vehicle.

The non-thermoplastic adhesive may further comprise an adjunct that creates a negative electric charge when saturated with water. The non-thermoplastic adhesive may comprise one or more of polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, grafted starch, the product of alkylation of polyethyleneimine by methylchloride, the product of alkylation of polyaminoamides with epichlorohydrine, cationic polyacrylamide with cationic monomers, and combinations thereof.

The vehicle may comprise one or more of water, methanol, ethanol, n-propanol, n-butanol, acetone, ethyl acetate, methyl acetate, dimethyl sulfoxide, acetonitrile, dimethylformamide, chloroform, and combinations thereof.

The solubilizing agent may comprise one or more of hydrochloric acid, sulfuric acid, nitric acid, phosphoric acid, tartaric acid, acetic acid, formic acid, propionic acid, ascorbic acid, glutamic acid, lactic acid, maleic acid, malic acid, succinic acid, carboxylic acid, and combinations thereof.

Those of skill in the field of the disclosure will understand log reduction to mean that the concentration of organisms in a given sample is reduced by a number of factors of ten between the initial concentration and the concentration after filtering. Thus, a reduction of organisms, for example, virus particles, of 4 log means that the concentration of virus particles is reduced by a factor of 10⁴ or 10,000-fold and a reduction of 5 log means that the concentration is reduced by a factor of 10⁵ or 100,000-fold. Virus concentration in a sample is typically expressed as the number of plaque forming units per liter of water (PFU/l). Thus, the effectiveness of a filter to remove viruses is determined by providing effluent to be filtered with a known PFU/l of a test organism, usually MS-2 phage and determining the PFU/l of the output of the filter as a factor of the initial concentration. Thus, a filter that reduces an initial viral concentration of 10⁷ PFU/l of input water to 10² PFU/l has a log reduction of virus of 5 log.

### EXAMPLE 1

A prototype filter element material 15 was formed from smaller particle size lignite particles and larger particle size lignite particles as follows. The element included about 50% large size particles and 50% small particles. The smaller particle size material, fine lignite powder, HYDRODARCO® M, was obtained from Cabot Norit Americas, Inc. The powder was analyzed by the manufacturer and had a particle size of 100×325 mesh, with above 90% by weight of particles smaller than 325 mesh with a D50 of approximately 15 microns. The larger particle size material, granulated Lignite 3000, was also obtained from Cabot Norit Americas, Inc. The material was analyzed by the manufacturer to have a mean particle size (D50) of about 310 microns. The smaller particles were adhered to surfaces of the larger particles using a non-thermoplastic adhesive, as described in U.S. Provisional Patent Appl. No. 62/868,885, filed Jun. 29, 2019 and in co-pending U.S. patent application Ser. No. 16/915,166, filed Jun. 29, 2020 which are incorporated herein by reference.

A gluing solution was formed by combining a non-thermoplastic adhesive material with a solvent. The adhesive material was chitosan powder manufactured by Hard Eight Nutrition, LLC d/b/a/BulkSupplements.com and 20% by weight poly-diallyl dimethyl ammonium chloride (p-DADMAC), Product CS91 manufactured by Kemira Oyj. The solvent was formic acid and water. The gluing solution was prepared by mixing 35 grams of Chitosan powder and 25 ml of the p-DADMAC solution with 450 ml reverse osmosis filtered, deionized (RO/DI) water and 25 ml of the formic acid. The mixture was placed in a container on hot plate equipped with a magnetic stirrer. A magnetic stirring bar was put in the container and used to stir the mixture. The mixture was heated to about 50 C and stirred for about 24 hours until all of the Chitosan powder was observed to have dissolved. The finished gluing solution was cooled to room temperature.

About 250 grams of the fine lignite powder as mixed with 250 grams of the lignite granules in a stand mixer. The mixer was equipped with a heated mixing bowl. About 500 grams of the gluing solution discussed above was added to the bowl and the mixer was energized to mix the materials and form a paste. The bowl heater was set to about 105 C and the mixture was allowed to dry while being agitate for about 90 minutes. As the solvent was removed and as the formic acid decomposed, the paste reverted to granules. The granules were placed in an oven at about 105 C and allowed to dry for several hours.

Approximately 69 grams of the granular material mixed with approximately 13 grams of the same binder as in Example 1, that is, Ultra High Molecular Weight Polyethylene resin pellets. The mixture was placed in the cylindrical mold as in Example 1. The mold was closed and compression was applied while the mold was heated to about 180 C. The molded material was allowed to cool, solidifying the binder, and adhering the granules with one another to create a filter element with an open-spaced structure. The resulting filter element has a density of 0.596 grams/cm³ and a surface area of 45.6 cm² across the face of the filter element.

### EXAMPLE 2

A filter apparatus according to an embodiment of the disclosure was constructed as shown in FIG. 1. First filter element 4 was a ceramic candle filter. Second filter element 12 was prepared as described in Example 1.

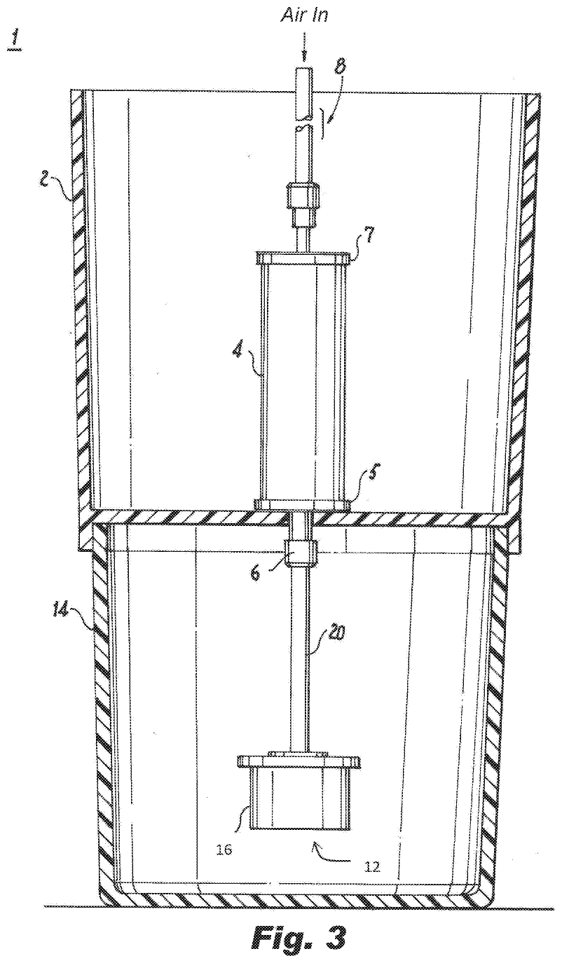

FIG. 3 shows another embodiment of the disclosure. As with the embodiment discussed with regard to FIG. 1, a first filter element 4 is provided inside a water reservoir 2. Housing portion 5 connects with coupling 6. Extending from the bottom of coupling 6 is extension tube 20. Tube 20 is connected with the top of housing 16 so that water flowing downward from first element 4, through coupling 6 travels through tube 20 and into second filter element 12. By providing extension tube 20 between coupling 6 and housing 16, water flowing downward through the apparatus under the force of gravity has a greater head pressure when it encounters second filter element 12. In some embodiments, second element 12 may introduce a greater pressure drop for fluid flowing through the element than the pressure drop created by fluid flowing through the first filter element 4. By providing additional head pressure at the outflow of extension tube 20, the throughput of the filter system 1 may be improved. According to one embodiment, the length of extension tube 20 is selected to place housing 16 between about 6 inches and 36 inches below coupling 6, providing between about 0.22 pounds per square inch (psi) and 1.3 psi of head pressure between the outlet of the first filter 4 and the second filter 12.

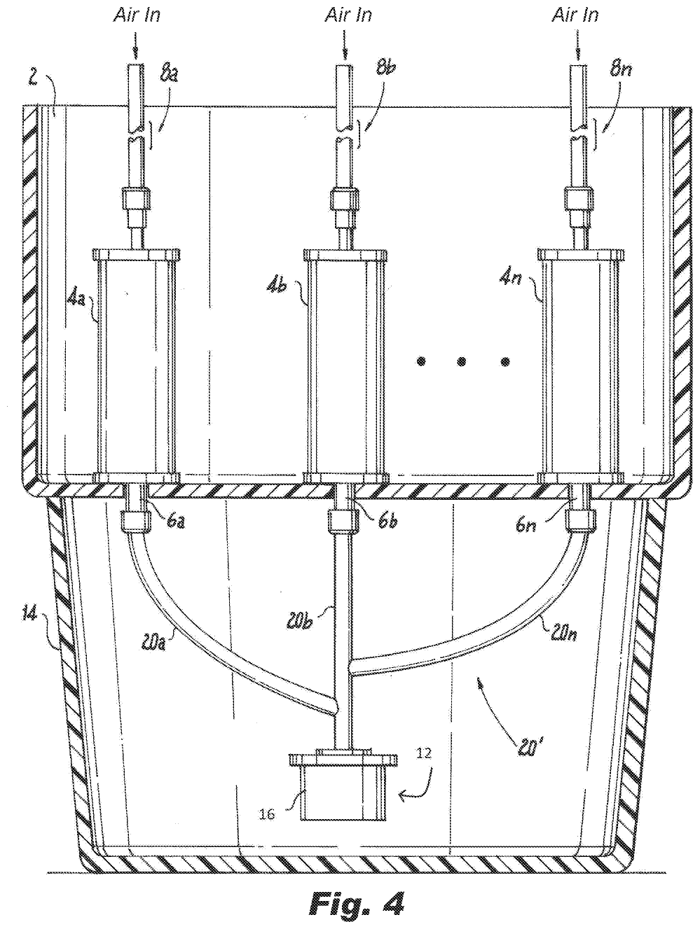

FIG. 4 shows a further embodiment of the disclosure. In this embodiment, multiple first filters 4a, 4b, . . . 4n are each connected with housing 16 of second filter 12. As in the embodiments described with respect to FIGS. 1, 2, and 3, first filters 4a, 4b, . . . 4n are each disposed in reservoir 2. Each is connected with a respective pressure equalizing tube 8a, 8b, . . . 8n. Each is connected with a respective coupling 6a, 6b, . . . 6n that provides a water-tight seal with the bottom surface of the reservoir 2 and a path for water to flow downward from the respective first filters to second filter element 12. Hose assembly 20′ is connected with the couplings 6a, 6b, . . . 6n. According to this embodiment, three upper branches of assembly 20′ 20a, 20b, . . . 20n are connected with respective ones of the couplings 6a, 6b, . . . 6n. At its lower end, assembly 20′ connects with housing 16. According to this embodiment, the outputs of the first filters 4a, 4b, . . . 4n are combined and flow through second filter 12. Such an arrangement may be advantageous where the rate of flow through individual filters 4a, 4b, . . . 4n are each less than the maximum flow rate of second filter 12 at a given head pressure. For example, in regions where water has high concentrations of solid materials that are captured by ceramic candle filters comprising elements 4a, 4b, . . . 4n, the throughput of one or more of these filters may be diminished as the solid material accumulates on the first filter elements. The useful lifespan of the filter system shown in FIG. 4 may be increased by providing multiple first filters. The embodiments disclosed here shows three first filter elements connected with a single second filter element. A greater or fewer number of first filter elements could be provided within the scope of the disclosure.

According to a further embodiment, instead of, or in addition to providing multiple first filters 4a, 4b, . . . 4n, multiple second filter housings 16 each equipped with a second filter element 12 may be provided. In these embodiments, assembly 20′ is modified to connect the multiple first and second filter elements. According to one embodiment, two or more second filter elements 12 are each supplied by one, two, or more first filter elements.

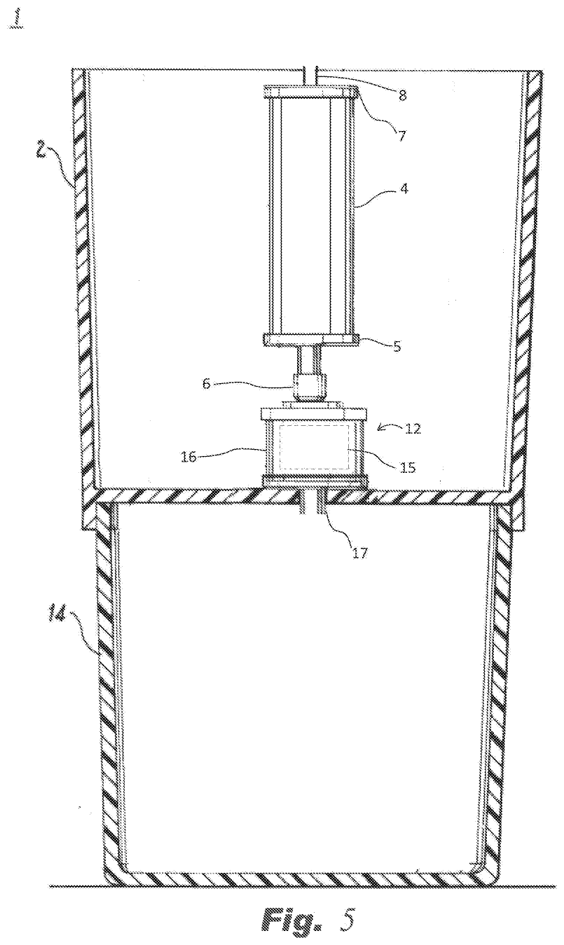

FIG. 5 shows a further embodiment of the disclosure. As with previous embodiments, first filter element 4 is connected by coupling 6 to second filter element 12. In this embodiment, first filter element 4 and second filter element 12 are positioned within reservoir 2. First filter element 4 may be a ceramic filter as disclosed in the embodiments described above. According some embodiments, filter element 4 is hollow cylinder designed to allow water or other fluid to flow through pores from the outer surface into a hollow inner space. First filter housing portions 7 and 5 at the top and bottom ends of element 4 close the ends of the hollow cylinder. Water in reservoir 2 flows through the surface of element 4 and into the hollow interior.

Pressure equalizing tube 8 is connected with the top housing 7 and extends upward a sufficient distance to extend above the surface of water in reservoir 2. In some embodiments, tube 8 extends above the top edge of reservoir 2. Tube 8 allows air to flow into and out from the hollow inner space of filter element 4. This assures that air will not become trapped inside element 4. Such trapped air might impede flow of water through first filter element 4.

Coupling 6 is connected with bottom housing 5. As with previous embodiments, coupling 6 joins element 4 with second filter element 12. Coupling may be a threaded connection, a snap connection, a dairy fitting, and interference fitting, or other known connection mechanism.

Second filter element 12 comprises a housing 16. Within housing 16 is second filter element 15, as described in the previous embodiments. Housing 16 is impervious to water so that water from reservoir 2 enters filter element 12 only through coupling 6 from first filter element 4.

At the bottom of second filter housing 16 is outlet 17. Outlet 17 extends through the bottom surface of reservoir 2 and into catch basin 14. A seal is formed between the bottom surface of housing 16 and the bottom of reservoir 2 and/or between the outer surface of outlet 17 and the bottom of the reservoir 2. This seal prevents water from bypassing the filter elements 4, 12.

In operation, water or other fluid to be filtered is put in reservoir 2. The water flows through pores in first filter element 4, displacing air from the interior of element 4 through tube 8. The water is partially filtered by passing through element 4. According to some embodiments, element 4 is a ceramic candle filter that removes particles larger than a certain size, for example, 0.5 microns. According to a preferred embodiment first filter element 4 reduced the concentration of organic acid in water flowing from reservoir 2 by between about 40% and 60%. According to some embodiments, the performance of components of filtration system 1 is characterized using humic acid (Humic acid technical grade; CAS No. 68131-04-4; manufactured by MilliporeSigma).

Prefiltered water flows downward from first element 4 through coupling 6 and then through second filter element 12. Second element 12 may be formed as described on co-pending U.S. patent application Ser. No. 16/915,166, filed on Jun. 29, 2020 and/or U.S. patent application Ser. No. 16/915,125, filed on Jun. 29, 2020, which are incorporated herein by reference. Having passed through second element 12, the water flows downward through outlet 17 into catch basin 14.

According to some embodiments, where second filter element material 15 is formed using carbon particles with a substantial portion of their porosity comprised of epipores, where the prefiltered water has a concentration of humic acid of about 10 ppm, the humic acid concentration is reduced to less than 2 ppm, preferably less than about 1 ppm, and most preferably to less than about 0.3 ppm after flowing through the second filter element. According to other embodiments, the initial concentration of organic acid may be between 100 ppm and 10 ppm. The organic acid may be selected from one or more of humic acid, fulvic acid, or tannic acid and combinations thereof.

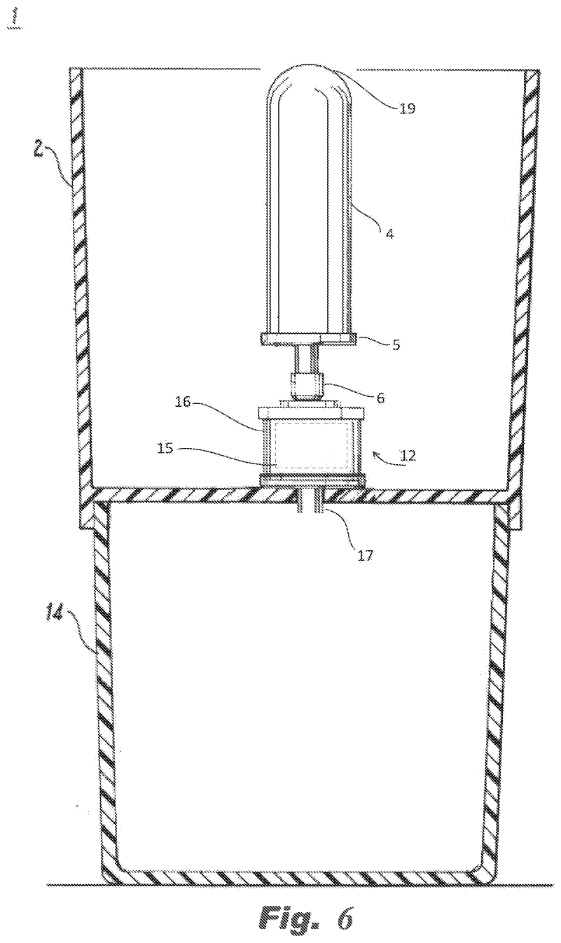

FIG. 6 shows another embodiment of the disclosure. Reservoir 2 holds a quantity of water or other fluid to be filters. First filter element 4 is positioned within reservoir 2. In this embodiment, first filter element 4 is hollow and has a closed, dome-shaped portion 19 at an upper end. As with previous embodiments, filter element 4 may be a ceramic filter with pores adapted to allow fluid to pass through the surface of the filter and into the hollow interior space while stopping the passage of particles above a certain size, for example, 0.5 microns. The lower end of filter element 4 is closed by lower housing 5. As with the previous embodiment, lower housing 5 is connected with coupling 6.

As with the previous embodiments, coupling joins first filter element 4 with second filter element 12. Coupling may be a threaded connection, a snap connection, a dairy fitting, and interference fitting, or other known connection mechanism.

Second filter element 16 includes filter element material 15. Filter element material 15 may be formed as disclosed in the previous embodiments. Water or other fluid in reservoir 2 flows through the pores of first filter element 4 and downward through coupling 6 and then through second filter 12. The filtered water or other fluid flows through outlet 17 into catch basin 14.

In some embodiments, first filter element 4 extends to a height within reservoir 2 above the surface of water in the reservoir. According to other embodiments, first filter element 4 extends above upper edge of reservoir 2. Such an arrangement allows air to diffuse through the portion of first filter element 4 extending above the level of water in the reservoir to maintain the pressure inside the filter element at or near ambient pressure.

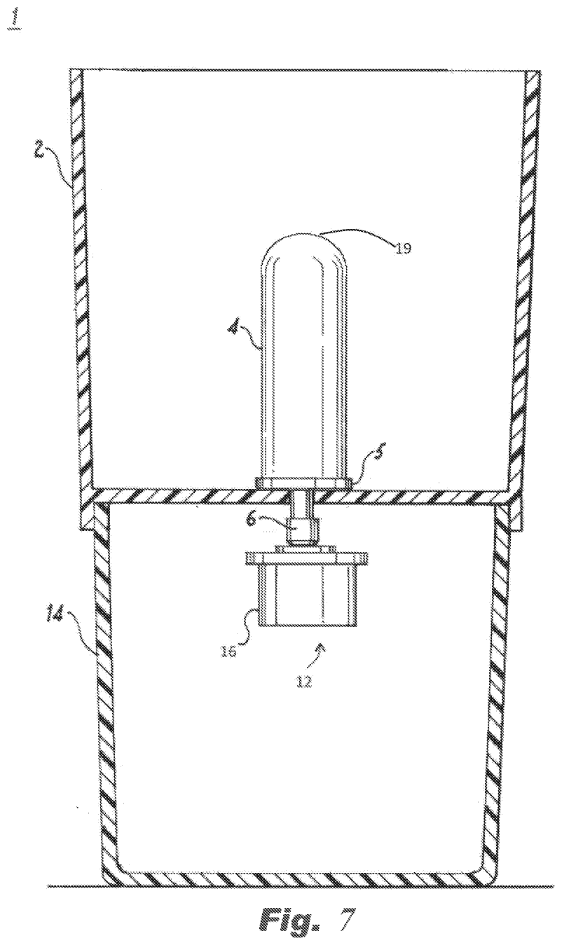

FIG. 7 shows another embodiment of the disclosure. As with the embodiment shown in FIG. 6, first filter element 4 is positioned within reservoir 2. First filter element 4 has a hollow interior space and is closed at an upper end by a hemispherical portion 19. The lower end of filter element 4 is engaged with lower filter housing 5 that closes the lower end of the interion space.

Housing 5 connects with coupling 6. As described above, coupling 6 removably connects first filter element 4 with second filter element 12. In the embodiment of FIG. 7, second filter element 12 is positioned below the bottom surface of reservoir 2. An opening is provided at the lower side of second filter 12. As with the previously described embodiments, water or other fluid flows from reservoir 2 into the internal space within first filter element 4, downward through coupling 6 and through second filter element 12. The filtered fluid flows from the opening at the bottom of second filter element 12 into catch basin 14.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

We claim:

1. A filter system comprising:
a first filter element in fluid communication with a source of a raw fluid, wherein the raw fluid flows through the first filter element to generate a prefiltered fluid; and
a second filter element in fluid communication with the first filter element, wherein the prefiltered fluid from the first filter element flows through the second filter element to generate a filtered fluid,
wherein the first filter element comprises a material adapted to stop the passage of materials greater than 0.5 micron,
wherein the second filter element is adapted to remove an organic substance from the fluid,
wherein the organic substance comprises an organic acid,
wherein the raw fluid has an initial concentration of the organic acid,
wherein, the initial concentration of the organic acid in the raw fluid is reduced by between about 40% and about 60% to generate the prefiltered fluid with a prefiltered concentration of the organic acid, and
wherein after the prefiltered fluid flows through the second filter element, the prefilter concentration of organic acid is reduced by greater than about 80% to a filtered concentration of the organic acid in the filtered fluid.

2. The filter system of claim 1, wherein the fluid is water.

3. The filter system of claim 2, wherein the first filter element comprises one or more of a ceramic body and a hollow fiber membrane filter.

4. The filter system of claim 1, further comprising a reservoir holding a quantity of the fluid, wherein the reservoir, the first filter element, and the second filter element are arranged vertically and wherein the fluid flows from the reservoir and through the first and second filter elements by a pressure gradient caused by gravity.

5. The filter of claim 1, wherein the second filter element comprises first filter media particles adhered to surfaces of second media particles by a non-thermoplastic gluing material.

6. The filter of claim 5, wherein the non-thermoplastic gluing material comprises:
a polymer comprising chitosan and poly-diallyl dimethyl ammonium chloride;
a vehicle comprising water; and
a solubilizing agent,
wherein the solubilizing agent comprises one or more of tartaric acid, acetic acid, formic acid, propionic acid, ascorbic acid, glutamic acid, lactic acid, maleic acid, malic acid, succinic acid, carboxylic acid, and combinations thereof.

7. The filter system of claim 5, wherein the second filter element further comprises a binder and wherein the second media particles are adhered to one another by the binder.

8. The filter system of claim 4, further comprising a first housing in fluid communication with the reservoir and holding the first filter element, a second housing holding the second filter element, and a coupling in fluid connection between the first housing and second housing, wherein the coupling extends through a vertical distance from the first housing to the second housing, and wherein a head pressure at the second filter element is greater than 0.25 psi.

9. The filter system of claim 4, further comprising an ambient pressure equalization tube, the tube extending vertically upward from the first housing, wherein the fluid in the reservoir defines a fluid level, and wherein the tube extends vertically above the fluid level.

10. The filter system of claim 8, wherein the first and second filter elements are removably housed in the respective first and second housings.

11. The filter system of claim 1, wherein the organic substance further comprises one or more of bacteria, viruses, and cysts.

12. The filter system of claim 1, wherein the organic acid is one or more of humic acid, fulvic acid, and tannic acid.

13. The filter system of claim 1, wherein the second filter element comprises a porous material with a total pore volume is greater than about 0.4 cc/g, where the percentage of the total pore volume provided by epipores is above about 40%, and wherein the pore volume provided by micropores is less than about 0.1 cc/g.14.

14. The filter system of claim 1, wherein a flux of fluid through the filter system greater than 0.7 ml/min/cm².

15. The filter system of claim 5, wherein the first filter media particles have a first mean particle size, wherein the second media particles have a second mean particle size, wherein the first media particles are adhered to surfaces of the second media particles with the non-thermoplastic adhesive to form filter material particles, wherein the filter material particles have a third mean particle size, and wherein the third mean particle size is larger than the first mean particle size.

16. The filter system of claim 15, wherein the first mean particle size is between about 1 and about 75 um.

17. The filter system of claim 15, wherein the second mean particle size is between about 75 and about 3000 um.

18. The filter system of claim 15, wherein the third mean particle size is between about 75 um and 2000 um.

19. The filter system of claim 15, wherein the second filter element further comprises a binder, wherein the filter material particles are connected with one another by the binder to form the filter element, wherein interstitial spaces are formed between filter material particles, and wherein a portion of the first filter media particles are positioned within the interstitial spaces.

20. The filter system of claim 8, wherein the first housing comprises a plurality of first housings, each housing having a respective one of a plurality of first filter elements, wherein the hose comprises one or more branches, and wherein the coupling comprises a hose that connects the plurality of first housings to the second housing.
